(19) United States
(12) Patent Application Publication
(10) Pub. No.: US 2022/0138233 A1
(43) Pub. Date: May 5, 2022

(54) System and Method for Partial Name Matching Against Noisy Entities Using Discovered Relationships

(71) Applicant: International Business Machines Corporation, Armonk, NY (US)

(72) Inventors: Christopher F. Ackermann, Chantilly, VA (US); Charles E. Beller, Baltimore, MD (US); Michael Drzewucki, Woodbridge, VA (US)

(21) Appl. No.: 17/089,465

(22) Filed: Nov. 4, 2020

(51) Int. Cl. G06F 16/28; G06F 16/2457; G06F 16/248; G06F 40/284; G06F 40/30

(52) U.S. Cl. CPC G06F 16/288; G06F 16/24578; G06F 40/30; G06F 40/284; G06F 16/248

(57) ABSTRACT

A method, system and computer-usable medium are disclosed to identify a set of entity names based on a partial name of the entity utilizing discovered relationships. A partial name from a user is received as to the entity in order to retrieve a plurality of names of the entity in a corpus which can be a body or works, document, etc. References to the entries containing the partial name are retrieved from the corpus. A natural language processing is applied to content associated with references to identify candidate entities. A similarity is performed as to the identified candidate entities to form a similarity assessment, and from the candidate entities a selection is made based on a merging criteria.

### GOVERNMENT CONTRACT

This invention was made with government support under 2018-18010800001. The government has certain rights to this invention.

### BACKGROUND OF THE INVENTION

### Field of the Invention

The present invention relates in general to the field of computers and similar technologies, and in particular to software utilized in this field. Still more particularly, it relates to a method, system, and computer-usable medium for searching for and retrieving results for entities which are represented multiple times which can be due to noisy data collection.

### Description of the Related Art

With the increased usage of computing networks, such as the Internet, users are currently inundated and overwhelmed with the amount of information available to them from various structured and unstructured sources. Information gaps abound as users try to piece together what they can find that they believe to be relevant during searches for information on various subjects. To assist with such searches, recent research has been directed to generating knowledge management systems which may take an input, analyze it, and return results indicative of the most probable results to the input. Knowledge management systems provide automated mechanisms for searching through a knowledge base with numerous sources of content, e.g., electronic documents, and analyze them with regard to an input to determine a result and a confidence measure as to how accurate the result is in relation to the input.

When conducting a search for a particular entity, users sometimes only have a partial name for the entity (e.g., “Jordan”). A common search approach is to offer an auto completion feature that shows known names, which may exist in a source such as a data base, that match the partial name (e.g., “Jordan”) entered by the user. Such a search approach may only work if the names in the source (e.g., database) are well formatted and curated.

When the names are based on an automated named entity extraction method, the same entity may be recorded under different names. For example, “Michael Jordan” may appear as “Michael Jeffrey Jordan”, “Michael J. Jordan”, “Michael Jordan Touchdown”, “Basketball MVP Michael Jordan”, etc. There can be significant noise that severely impacts the usefulness of results. With a noisy set of entity names, the list of suggested names is often large and difficult to understand as the same entity is represented many times with different surface forms (i.e., form of a word as it appears in the text).

Therefore, it is desirable to implement a search approach that generates a list of relevant name completions without overwhelming the user. Such a search approach should reduce the number of times the same entity is represented in the suggestions while distinguishing entities that are truly different.

### SUMMARY OF THE INVENTION

A method, system and computer-usable medium are disclosed to identify a set of entity names based on a partial name of the entity utilizing discovered relationships. A partial name from a user is received as to the entity in order to retrieve a plurality of names of the entity in a corpus which can be a body or works, document, etc. References to the entries containing the partial name are retrieved from the corpus. A natural language processing is applied to content associated with references to identify candidate entities. A similarity is performed as to the identified candidate entities to form a similarity assessment, and from the candidate entities a selection is made based on a merging criteria.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a simplified block diagram of an information handling system capable of performing computing operations;

FIG. 3 is a simplified block diagram of a system capable of implementing the described operations and methods;

FIG. 4 is a generalized flow chart for identifying completions to a partial entity name;

FIG. 5 is a generalized flow chart of the operation of scope detection.

### DETAILED DESCRIPTION

The present application relates generally to improving searching for and retrieving results for entities which are represented multiple times which can be due to noisy data collection. In various embodiments, disambiguation is performed on based on name similarity in order to reduce duplication. Various implementations make sure of character-based, and term frequency and inverse document frequency (TF-IDF) based similarity scores for disambiguation to group similar entities. The described systems and methods provide support for instances where variants for the same entity have relatively large string distances.

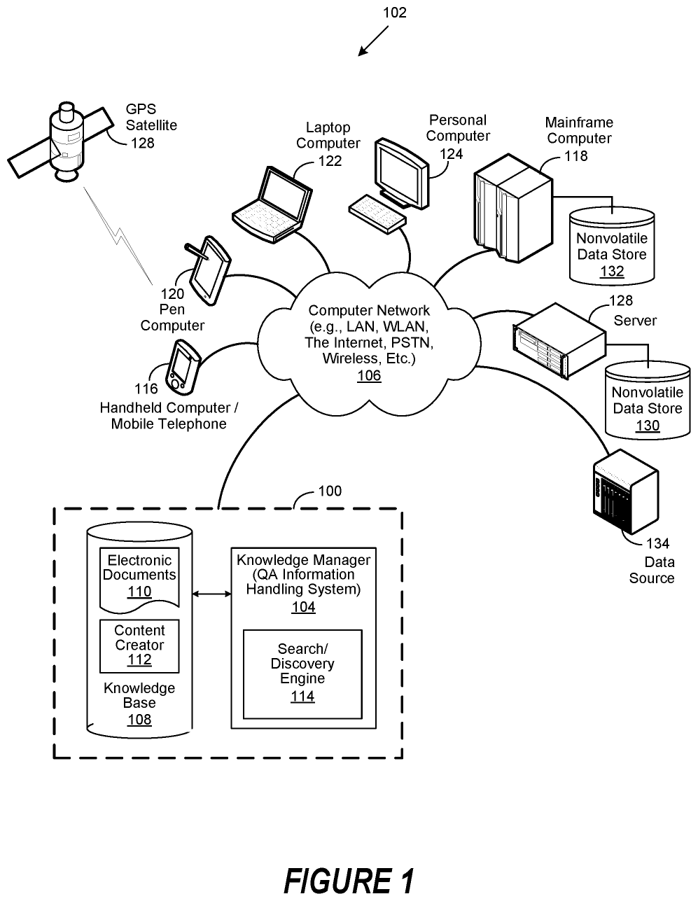

FIG. 1 depicts a schematic diagram of one illustrative embodiment of a knowledge manager system (e.g., a question/answer creation (QA)) system 100 which is instantiated in a distributed knowledge manager in a computer network environment 102. One example of a question/answer generation which may be used in conjunction with the principles described herein is described in U.S. Patent Application Publication No. 2011/0125734, which is herein incorporated by reference in its entirety. Knowledge manager 100 may include a knowledge manager information handling system computing device 104 (comprising one or more processors and one or more memories, and potentially any other computing device elements generally known in the art including buses, storage devices, communication interfaces, and the like) connected to a computer network 106. The network environment 102 may include multiple computing devices in communication with each other and with other devices or components via one or more wired and/or wireless data communication links, where each communication link may comprise one or more of wires, routers, switches, transmitters, receivers, or the like. Knowledge manager 100 and computer network environment 102 may enable question/answer (QA) generation functionality for one or more content users. Other embodiments of knowledge manager 100 may be used with components, systems, sub-systems, and/or devices other than those that are depicted herein.

Knowledge manager 100 may be configured to receive inputs from various sources. For example, knowledge manager 100 may receive input from the computer network environment 102, computer network 106, a knowledge base 108 which can include a corpus of electronic documents 110 or other data, a content creator 112, content users, and other possible sources of input. In various embodiments, the other possible sources of input can include location information. In one embodiment, some or all of the inputs to knowledge manager 100 may be routed through the computer network 106. The various computing devices on the computer network environment 102 may include access points for content creators and content users. Some of the computing devices may include devices for a database storing the corpus of data. The knowledge manager information handling system computing device 104 further includes search/discovery engine 114.

The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator 112 creates content electronic documents 110 for use as part of a corpus of data with knowledge manager 100. The content in electronic documents 110 may include any file, text, article, or source of data for use in knowledge manager 100. Content users may access knowledge manager 100 via a network connection or an Internet connection (represented as to the computer network 106) and may input questions to knowledge manager 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language Processing (NLP), such that knowledge manager 100 can be considered as a NLP system, which in certain implementations performs the methods described herein. In one embodiment, the process sends well-formed questions (e.g., natural language questions, etc.) to the knowledge manager. Knowledge manager 100 may interpret the question and provide a response to the content user containing one or more answers to the question. In some embodiments, knowledge manager 100 may provide a response to users in a ranked list of answers. In various embodiments, the one or more answers take into account location information.

One such knowledge manager information handling system computing device 104 is the IBM Watson™ system available from International Business Machines (IBM) Corporation of Armonk, N.Y. The IBM Watson™ system is an application of advanced natural language processing, information retrieval, knowledge representation and reasoning, and machine learning technologies to the field of open domain question answering. The IBM Watson™ system is built on IBM's DeepQA technology used for hypothesis generation, massive evidence gathering, analysis, and scoring. DeepQA takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

In some illustrative embodiments, knowledge manager 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds, or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

Types of information handling systems that can utilize QA system 100 range from small handheld devices, such as handheld computer/mobile telephone 116 to large mainframe systems, such as mainframe computer 118. Examples of handheld computer 112 include personal digital assistants (PDAs), personal entertainment devices, such as MP3 players, portable televisions, and compact disc players. Other examples of information handling systems include pen, or tablet, computer 122, laptop, or notebook, computer 122, personal computer system 124, and server 126. In certain embodiments, the location information is determined through the use of a Geographical Positioning System (GPS) satellite 128. In these embodiments, a handheld computer or mobile telephone 116, or other device, uses signals transmitted by the GPS satellite 128 to generate location information, which in turn is provided via the computer network 106 to the knowledge manager system 100 for processing. As shown, the various information handling systems can be networked together using computer network 106. Types of computer network 106 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems.

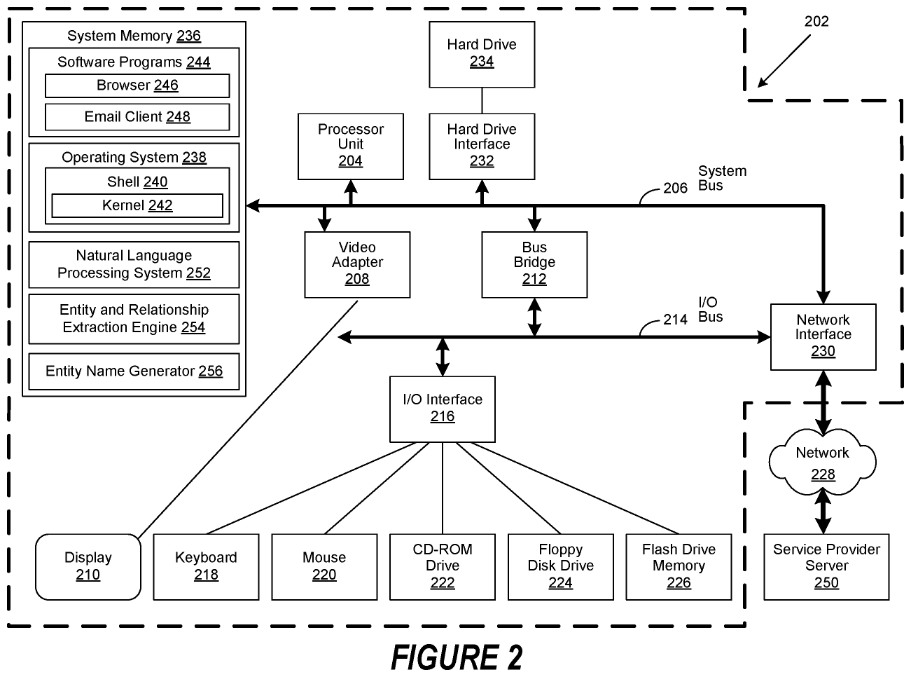

Many of the information handling systems include nonvolatile data stores, such as hard drives and/or nonvolatile memory. Some of the information handling systems shown in FIG. 1 depicts separate nonvolatile data stores (server 126 utilizes nonvolatile data store 130, and mainframe computer 118 utilizes nonvolatile data store 132. A nonvolatile data store 134 can be a component that is external to the various information handling systems or can be internal to one of the information handling systems. An illustrative example of an information handling system showing an exemplary processor and various components commonly accessed by the processor is shown in FIG. 2.

FIG. 2 illustrates an information processing handling system 202, more particularly, a processor and common components, which is a simplified example of a computer system capable of performing the computing operations described herein. Information processing handling system 202 includes a processor unit 204 that is coupled to a system bus 206. A video adapter 208, which controls a display 210, is also coupled to system bus 206. System bus 206 is coupled via a bus bridge 212 to an Input/Output (I/O) bus 214. An I/O interface 216 is coupled to I/O bus 214. The I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

The information processing information handling system 202 is able to communicate with a service provider server 252 via a network 228 using a network interface 230, which is coupled to system bus 206. Network 228 may be an external network such as the Internet, or an internal network such as an Ethernet Network or a Virtual Private Network (VPN). Using network 228, client computer 202 is able to use the present invention to access service provider server 250. In certain implementations, the network 228 is computer network 106 described in FIG. 1.

A hard drive interface 232 is also coupled to system bus 206. Hard drive interface 232 interfaces with a hard drive 234. In a preferred embodiment, hard drive 234 populates a system memory 236, which is also coupled to system bus 206. Data that populates system memory 236 includes the information processing information handling system's 202 operating system (OS) 238 and software programs 244.

OS 238 includes a shell 240 for providing transparent user access to resources such as software programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. While shell 240 generally is a text-based, line-oriented user interface, the present invention can also support other user interface modes, such as graphical, voice, gestural, etc.

As depicted, OS 238 also includes kernel 242, which includes lower levels of functionality for OS 238, including essential services required by other parts of OS 238 and software programs 244, including memory management, process and task management, disk management, and mouse and keyboard management. Software programs 244 may include a browser 246 and email client 248. Browser 246 includes program modules and instructions enabling a World Wide Web (WWW) client (i.e., information processing information handling system 202) to send and receive network messages to the Internet using Hyper Text Transfer Protocol (HTTP) messaging, thus enabling communication with service provider server 250. In various embodiments, software programs 244 may also include a natural language processing system 252. In various implementations, the natural language processing system 252 can include a false negation module 254 and a binary classifier 256. In these and other embodiments, the invention 250 includes code for implementing the processes described herein below. In one embodiment, the information processing information handling system 202 is able to download the natural language processing system 252 from the service provider server 250.

The hardware elements depicted in the information processing information handling system 202 are not intended to be exhaustive, but rather are representative to highlight components used by the present invention. For instance, the information processing information handling system 202 may include alternate memory storage devices such as magnetic cassettes, Digital Versatile Disks (DVDs), Bernoulli cartridges, and the like. These and other variations are intended to be within the spirit, scope, and intent of the present invention.

In various embodiments, the system memory 236 includes a natural language processing (NLP) system 252 which can include code for implementing the processes described herein. Furthermore, system memory 236 can be configured with entity and relationship extraction engine 254 and entity name generator 256. As further described herein, the entity and relationship extraction engine 254 extracts a set of entities and a set of relationships between these entities using an automated entity and relationship extraction method. The extraction can be performed on a corpus(es) of unstructured documents as described herein. When names of entities are based on such an automated named entity extraction method, the same entity may be recorded under different names. Name variants may be stored in an entity store. As described herein, from the extracted set(s) of entities and set(s) of relationships, the entity name generator 256 is used in generating a list of name candidates that are potential completions to a user provided partial name. The name variants present in the entity store are disambiguated on query time to compile a smaller and more focused list of name candidates.

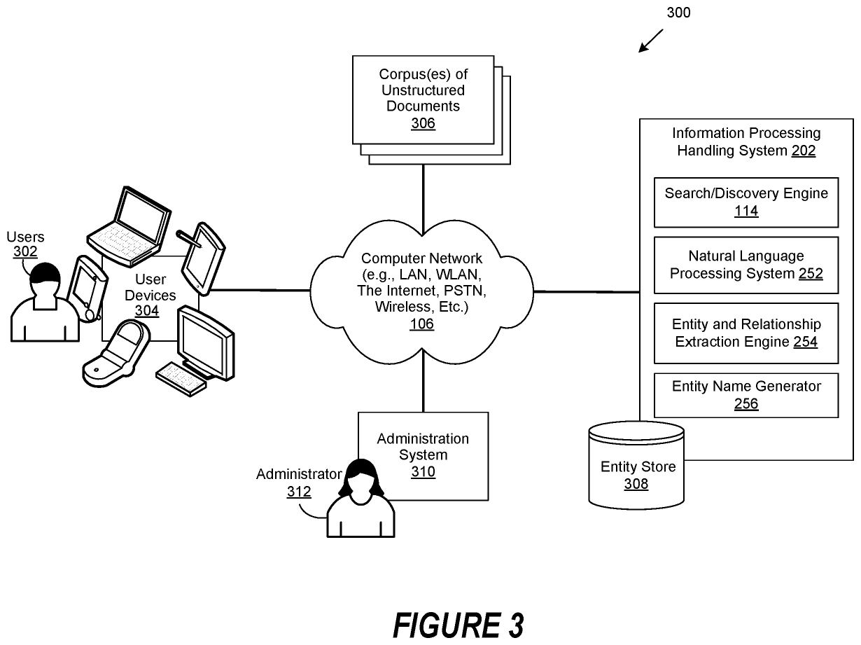

FIG. 3 shows a system capable of implementing the described operations and methods. In particular, the system 300 provides for searching for and retrieving results for entities which are represented multiple times which can be due to noisy data collection. In other words, the system 300 provides for partial name matching against noisy entities using discovered relationships.

The system 300 includes the computer network 106 described above, which connects multiple users 302 through user devices 304 to various other devices and systems, etc. as further described herein. In particular, a user device 304 can be implemented as information handling system. It is to be understood, that user device 304 can include all or some of the described elements of information handling system 202. Examples of user device 304 can include a personal computer, a laptop computer, a tablet computer, a personal digital assistant (PDA), a smart phone, a mobile telephone, smart watch (i.e., wearables), or other device that is capable of communicating and processing data.

The system 300 includes information processing handling system 202 as described in FIG. 2. User devices 304 allow users 302 to access information processing handling system 202 to perform searching, such as entity searching. It is to be understood that in certain implementations the information processing handling system 202 can be implemented as a cloud based system. In various embodiments, the information processing handling system 202 includes the search/discovery engine 114 described in FIG. 1, and the NLP system 252, the entity and relationship extraction engine 254, and entity name generator 256.

Various embodiments provide for the system 300 to include corpus(es) of unstructured documents 306, which can include body of works, sets of documents, etc. The corpus(es) of unstructured documents 306 can originate from various sources, such as databases, websites, data storages, etc. that are connected to the computer network 106.

In various implementations, the using an automated entity and relationship extraction method, the entity and relationship engine 254 extracts a set of entities and a set of relationships between the entities. When names of entities are based on an automated named entity extraction method, the same entity may be recorded under different names. Sets of entities and sets of relationships between the entities, and name variants may be stored in an entity store 308.

As further described herein, the extracted set(s) of entities and set(s) of relationships stored in entity store 308 is(are) accessed by the entity name generator 256. is used in generating a list of name candidates that are potential completions to a user 302 provided partial name. The name variants present in the entity store 308 are disambiguated on query time to compile a smaller and more focused list of name candidates.

Various embodiments provide for the system 300 to include an administrative system(s) 310, which is accessed and controlled by an administrator(s) 312. The administrative system(s) 310 can be implemented as information handling systems and connected to the network 106 and accesses information processing handling system 202.

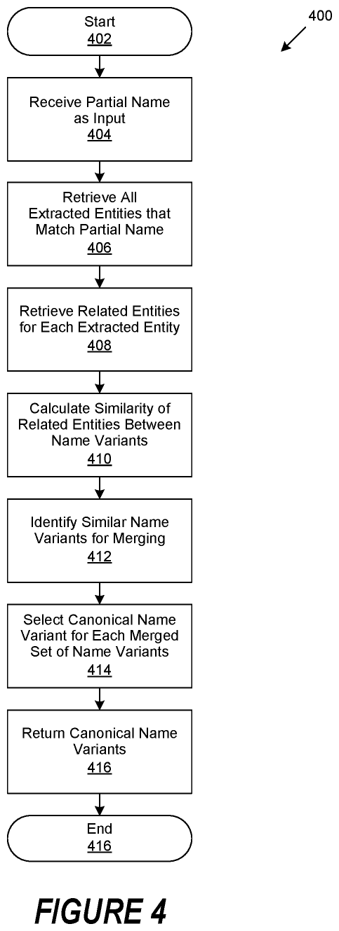

FIG. 4 is a generalized flowchart 4 for identifying completions to a partial entity name. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At step 402, the process 400 starts. At step 404, a partial name for an entity is received from a user 302. Users 302 may have the first or last name of an individual or a combination of multiple constituents. For example, a user 302 query can be “Jordan” or “Michael Jeffrey” which are partial for “Michael Jeffrey Jordan”.

At step 406, all extracted entity names matching the partial name of step 404 are retrieved. In certain implementations, a query on ingest is submitted against the set of entity names that were extracted from the unstructured document corpus(es) 306 and stored in entity store 308. The query returns all entity names that contain the query name constituents in any order.

In certain instances, unstructured document corpus(es) 306 contains additional noise (e.g., typos), rather than an exact match to query name constituents, and only an approximate match is needed. In certain implementations, an approach is to retrieve names that match query name constituents within some edit distance threshold, for example a maximum edit distance of “2”. The result at this step 406 can a large set of entity names that match the query name constituents. In such a set, distinct entities may be represented under multiple different names. Continuing with the example of “Michael Jordan” corresponding to the former professional basketball player, “Michael Jordan” can be represented as “Michael Jordan”, “Michael Jeffrey Jordan”, “Michael Jordan MVP”, “basketball player Michael Jordan”.

At step 408, related entities are retrieved for each entity name in step 406. At ingest, entity mentions and relationships or references are extracted from corpus(es) of unstructured documents 306. At this step, related entities are extracted for each of the name variants identified in step 406. In other words, given a name variant, the relationship store (i.e., entity store 308) is queried for any reference or relationship that involves a mention of that entity name variant. The following are examples of name variants with related entities in brackets. “The [basketball player Michael Jeffrey Jordan] was loyal to the [Chicago Bulls].” “[Michael Jordan] together with his team mate [Scottie Pippen] secured the win.” “[Michael Jordan] played for the [Chicago Bulls] when he won his first title.”

A unique set of related entity names is extracted. In other words, most of the relationship information is discarded and only the name, type and count of the related entity is retained. For example, “basketball player Michael Jordan”: [“Chicago Bulls”] “Michael Jordan”: [“Chicago Bulls”, “Scottie Pippen”].

In certain implementations, applying natural language processing (NLP) such as with NLP system 252 is used on content associated with the corpus references to identify candidate or related entities.

At step 410, similarity of related entities between name variants is calculated. Similarity between each pair of name candidates can be calculated by determining how many related entities are shared. Certain embodiments use different similarity metrics based on results produced for a given corpus and entity extraction method.

In a various embodiment, the similarity measure is a count of the number of related entities that two name variants share divided by the total number of related entities for the name variant with the fewest related entities. This can be an effective resource optimized method, after relationship extraction is performed and can provide acceptable performance results. Similarity can be considered high for name variants that refer to the same underlying entity.

At step 412, similar name variants are identified for merging. After similarity or a similarity assessment, between each pair of entities is calculated, name variants that appear to be similar can be merged and a subset determined. One approach is to merge name variants whose similarity is below a certain threshold. In practice, such an approach works well for name variants for which there are a sufficient number of related entities. Therefore, merge decision can be based on name variants with many entities and name variants with few related entities.

In the case with merging name variants with many related entities, the following can be performed. If both input name variants have at least three related entities, perform the following. If two entities have many related entities in common (e.g., according to the similarity metric described in step 410), merge the two entities. Take the name of the entity with the most related entities as the canonical name for that entity. This can ensure that the outlier names, such as “Basketball MVP Michael Jordan” are “absorbed” by more common occurrences like “Michael Jordan”.

In the case with merging name variants with few related entities, the following can be performed. Due to erroneous extraction, name variants can contain an adjacent prefix or suffix from the text surrounding the proper entity name in the text. For example, the following may be extracted “played with Michael Jordan, MVP” rather than simply “Michael Jordan”. Those types of entities are outliers and do not occur often across corpus(es) of unstructured documents 306. As a result, such name variants may only have a few related entities. If an entity has fewer than three related entities, the merging approach from step 410 which relies on related-entity overlap, can lead to aggressive over-merging. In these instances, name variants are merged if the name variants occur in the same document with another name variant. The procedure assumes that documents mention an entity more than once and use distinct names for distinct individuals. If present, “within-document coreference” can be leveraged.

At step 414, a canonical name variant is selected for each merged set of name variants. For a set of name variants as determined to be merged at steps 410 and 412, a canonical name is selected. The following procedure can be implemented. Each name variant is decomposed into its constituents, for example, by tokenizing on whitespace. The percentage of times a constituent is part of a name variant (i.e., its occurrence) is determined. The constituents whose occurrence is more than a specified threshold are considered the base constituents. These are constituents expected to be in the canonical name. The name variants are ranked such that those that contain all or most of the constituents without containing relatively many non-base constituents are favored to create a further subset. The following equations can be implemented.

score(variant)=w1*count base_constituents(variant)−w2*count non-base_consituents(variant) where w1 is a bonus weight and w2 is a penalty weight

or

score=count_base_consituents(variant)/count_all_consituents(variant)

In certain embodiments, individual constituents may be deferentially weighted by occurrence percentage or a-priori known importance (from an external source, such as an administrator 312 of FIG. 3). In such cases the count functions can be replaced by weighted sums. The top ranked name is selected as canonical.

At step 416, canonical names are returned to user 302. In certain implementations, the set of name variants are returned to user 302. In various embodiments, name variants can be annotated with the top few related entities for each name variant and returned to user 302. The information can be used to identify what name variant seems to be the one that best matches the entity the user is interested in. At step 418, the process 400 ends.

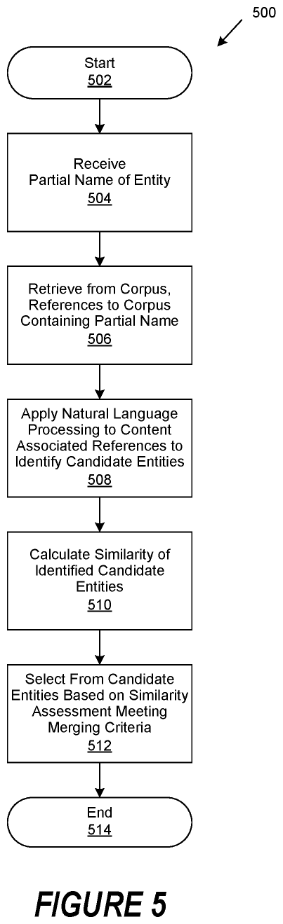

FIG. 5 is a generalized flowchart 500 for identifying a set of entity names based on a partial name of the entity utilizing discovered relationships. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At step 502, the process 500 is started. At step 504, receiving the partial name of the entity to retrieve a plurality of names of the entity in a corpus, such as a body of works, set of documents, etc., such as corpus(es) of unstructured documents 306 from a user, such as users(s) 304 is performed.

At step 506, retrieving from the corpus, references to entries in the corpus containing the partial name is performed.

At step 508, applying a natural language processing to a content associated with references to identify candidate or related entities C(C₁, C₂, . . . , Cₙ) is performed. In certain implementations, the NLP system 252 is used.

At step 510, calculating a similarity of the identified candidate entities C(C₁, C₂, . . . , Cₙ) to form a similarity assessment wherein Sᵢⱼ is a similarity assessment of Cᵢ to Cⱼ is performed.

At step 512, selecting from the candidate entities C(C₁, C₂, . . . , Cₙ) a subset C′ (C′₁, C′₂, C′ⱼ) based on the similarity assessment meeting a merging criteria. In certain implementations, the subset C′(C′₁, C′₂, C′ⱼ) is merged to form a reduced candidate subset C″(C″₁, C″₂, C″ₖ). Furthermore, implementations can provide to return at least one of the reduced candidate subset C″(C″₁, C″₂, C″ₖ) to the user. At step 514, the process 500 ends.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method for identifying a set of entity names based on a partial name of the entity utilizing discovered relationships comprising:
receiving the partial name of the entity to retrieve a plurality of names of the entity in a corpus from a user;
retrieving from the corpus, references to entries in the corpus containing the partial name;
applying a natural language processing to a content associated with references to identify candidate entities C(C1, C2, . . . , Cn);
calculating a similarity of the identified candidate entities C(C₁, C₂, . . . , Cₙ) to form a similarity assessment wherein Sᵢⱼ is a similarity assessment of Cᵢ to Cⱼ; and
selecting from the candidate entities C(C₁, C₂, . . . , Cₙ) a subset C′ (C′₁, C′₂, C′ⱼ) based on the similarity assessment meeting a merging criteria.

2. The method of claim 1, wherein the corpus comprises a body of works or a set of documents.

3. The method of claim 1 further comprising merging the subset C′(C′ ₁, C′₂, . . . , C′ⱼ) is merged to form a reduced candidate subset C″(C″₁, C″₂, . . . , C″ₖ).

4. The method of claim 3, wherein name variants are ranked such that those that contain all or most of constituents without containing relatively many non-base constituents are favored to create the candidate subset C″(C″₁, C″₂, . . . , C″ₖ).

5. The method of claim 3 further comprising returning at least one of the reduced candidate subset C″(C″₁, C″₂, . . . , C″ₖ) to the user.

6. The method of claim 1, wherein the merging criteria is based on name variants with many related entities or name variants with few related entities.

7. The method of claim 1, wherein an automated entity and relationship extraction method is performed on the corpus.

8. A system comprising:
a processor;
a data bus coupled to the processor; and
a computer-usable medium embodying computer program code, the computer-usable medium being coupled to the data bus, the computer program code used for identifying a set of entity names based on a partial name of the entity utilizing discovered relationships and comprising instructions executable by the processor and configured for:
receiving the partial name of the entity to retrieve a plurality of names of the entity in a corpus from a user;
retrieving from the corpus, references to entries in the corpus containing the partial name;
applying a natural language processing to a content associated with references to identify candidate entities C(C1, C2, . . . , Cn);
calculating a similarity of the identified candidate entities C(C₁, C₂, . . . , Cₙ) to form a similarity assessment wherein Sᵢⱼ is a similarity assessment of Cᵢ to Cⱼ; and
selecting from the candidate entities C(C₁, C₂, . . . , Cₙ) a subset C′ (C′₁, C′₂, . . . , C′ⱼ) based on the similarity assessment meeting a merging criteria.

9. The system of claim 8, wherein the corpus comprises a body of works or a set of documents.

10. The system of claim 8 further comprising merging the subset C′(C′₁, C′₂, . . . , C′ⱼ) is merged to form a reduced candidate subset C″(C″₁, C″₂, . . . , C″ₖ).

11. The system of claim 10, wherein name variants are ranked such that those that contain all or most of constituents without containing relatively many non-base constituents are favored to create the candidate subset C″(C″₁, C″₂, . . . , C″ₖ).

12. The system of claim 10 further comprising returning at least one of the reduced candidate subset C″(C″₁, C″₂, . . . , C″ₖ) to the user.

13. The system of claim 8, wherein the merging criteria is based on name variants with many related entities or name variants with few related entities.

14. A non-transitory, computer-readable storage medium embodying computer program code, the computer program code comprising computer executable instructions configured for:
receiving the partial name of the entity to retrieve a plurality of names of the entity in a corpus from a user;
retrieving from the corpus, references to entries in the corpus containing the partial name;
applying a natural language processing to a content associated with references to identify candidate entities C(C1, C2, . . . , Cn);
calculating a similarity of the identified candidate entities C(C₁, C₂, . . . , Cₙ) to form a similarity assessment wherein Sᵢⱼ is a similarity assessment of Cᵢ to Cⱼ; and
selecting from the candidate entities C(C₁, C₂, . . . , Cₙ) a subset C′ (C′₁, C′₂, C′ⱼ) based on the similarity assessment meeting a merging criteria.

15. The non-transitory, computer-readable storage medium of claim 14, wherein the corpus comprises a body of works or a set of documents.

16. The non-transitory, computer-readable storage medium of claim 14 further comprising merging the subset C′(C′₁, C′₂, C′ⱼ) merged to form a reduced candidate subset C″(C″₁, C″₂, C″ₖ).

17. The non-transitory, computer-readable storage medium of claim 16, wherein name variants are ranked such that those that contain all or most of constituents without containing relatively many non-base constituents are favored to create the candidate subset C″(C″₁, C″₂, . . . , C″ₖ).

18. The non-transitory, computer-readable storage medium of claim 16 further comprising returning at least one of the reduced candidate subset C″(C″ᵢ, C″₂, . . . , C″ₖ) to the user.

19. The non-transitory, computer-readable storage medium of claim 14, wherein the merging criteria is based on name variants with many related entities or name variants with few related entities.

20. The non-transitory, computer-readable storage medium of claim 14, wherein an automated entity and relationship extraction method is performed on the corpus.
